(19) United States
(12) Patent Application Publication
(10) Pub. No.: US 2004/0122688 A1
(43) Pub. Date: Jun. 24, 2004

(54) Portable autonomous rental store

(75) Inventor: Steven Richard Janda, Peoria, IL (US)

Correspondence Address: Finnegan, Henderson, Farabow,, Garrett & Dunner, L.L.P., 1300 I Street N.W., Washington, DC, 20005-3315, US

(73) Assignee: Caterpillar, Inc.

(21) Appl. No.: 10/326,569

(22) Filed: Dec. 23, 2002

(51) Int. Cl. G06F 17/60

(52) U.S. Cl. 705/1

(57) ABSTRACT

A method provides rental equipment to a customer including providing a portable container containing a piece of equipment at a location chosen by the customer and authorizing the customer to access the portable container. The method detects removal of the piece of equipment from the portable container and/or return of the piece of equipment to the portable container. Usage of the piece of equipment is tracked.

### TECHNICAL FIELD

The present invention relates generally to rental equipment businesses and, more particularly, to a system and method for improving the availability of rental equipment.

### BACKGROUND

Ensuring equipment availability is an important aspect of the rental equipment business today. Specifically, customers want the equipment they are renting to be ready and available whenever and wherever the equipment is needed. Customers often rent equipment to be used at a customer job site. This equipment may include large equipment, such as bulldozers or other machinery, as well as small equipment, such as jackhammers, air compressors, and tools. Further, customers may rent accessories, such as cords, hoses, or generators. Customers may also purchase goods, such as fuel, oil, feed, gloves, saw blades, drill bits, etc.

Current rental equipment systems are inconvenient for customers because equipment must often be picked up from and returned to a central rental location by a customer. This requires the customer to spend time and effort just to obtain the rental equipment. Frequently, equipment pick up and return must be performed during business hours, further complicating the rental process for the customer.

Furthermore, while customers sometimes know what equipment will be needed in advance, often a particular piece of equipment may be needed without advance notice. For example, a worker on a construction site may encounter unexpected difficulties and need a larger machine or a rental tool may break. Current rental equipment systems cannot adequately accommodate such last minute needs because the customer must often return to the central rental location to obtain the needed equipment. To meet a last-minute equipment need, customers in traditional systems may simply go to the nearest store, thereby taking business away from its regular rental supplier. Even a rental system that delivers rental equipment to the customer site cannot adequately satisfy last-minute rental needs because there is a delay while the customer orders the equipment and awaits its delivery. Further, delivery adds additional costs in most current systems.

Controlling costs of rental equipment is another important factor in today's rental equipment business. In particular, customers want to maximize the value received for the money spent to rent equipment. Often, a customer needs a piece of rental equipment for a very short amount of time. Conventional rental equipment systems can be costly in such a situation because a customer may spend more time to pick up and return a piece of equipment than is actually spent using the rented equipment. The additional cost in time and money to pick up and return the equipment makes an otherwise brief rental period much more costly. Furthermore, a customer may need a piece of equipment for only a small amount of time each day over several days or weeks. To avoid multiple pick-ups and returns, a customer may pay to rent the piece of equipment for the entire period, making the rental much more costly.

Additional costs may be incurred for customer sites that are difficult to reach. For example, a remote location or a secure location, such as a power plant or a prison, may require a great deal of time to complete equipment pick-ups and/or deliveries. The additional time costs customers money in current business systems, particularly for repeat rentals.

Some rental systems allow customers to rent objects, such as videotapes or library books, using a self-checkout system. One such system is disclosed in U.S. Pat. No. 6,195,006 for an Inventory System Using Articles with RFID Tags. This system tracks the removal and return of rented objects using radio frequency identification technology, enabling a customer to pick up and return rented objects without interacting with a clerk. However, this system does not provide for flexible availability of rental equipment at a customer site. Furthermore, such a system cannot easily accommodate last-minute equipment needs at a customer site.

The present invention is directed to overcoming one or more of the problems or disadvantages associated with the prior art.

### SUMMARY OF THE INVENTION

One aspect of the invention involves a method of managing rental equipment that includes sensing an identity of a customer accessing a portable container, detecting removal of a piece of equipment from the portable container, and tracking usage of the piece of equipment based on the identity and the removal detection.

Another aspect of the invention involves a method of managing rental equipment that includes sensing an identity of a customer accessing a portable container, detecting replacement of a piece of equipment to the portable container, and tracking usage of the piece of equipment based on the identity and the replacement detection.

Yet another aspect of the invention involves a method of providing rental equipment to a customer including providing a customer-specific rental facility containing a piece of equipment at a location chosen by the customer and authorizing the customer to access the customer-specific rental facility. Removal of the piece of equipment from the customer-specific rental facility and return of the piece of equipment to the customer-specific rental facility are detected, and usage of the piece of equipment is tracked.

Still another aspect of the invention involves a system for managing rental equipment that includes a portable container containing a piece of equipment for rent, an access controller that selectively allows a customer to access the portable container, and a sensor that detects removal of the piece of equipment from the portable container.

In a further aspect of the invention, a system provides a portable wireless communications infrastructure to a customer, including a local communication interface provided at a customer site, a remote computer connected to the local communication interface via a wide area network, and a wireless device provided to the customer at the customer site that communicates data about equipment rental to the remote computer via the local communication interface.

### BRIEF DESCRIPTION OF THE DRAWINGS

In the drawings:

FIG. 1 is a block diagram of a rental equipment business system, consistent with an exemplary embodiment of the present invention;

FIG. 2 is a flowchart of an exemplary equipment rental process, consistent with the present invention;

FIG. 3 is a block diagram of a rental equipment tracking system, consistent with an exemplary embodiment present invention; and

FIG. 4 is a flowchart of an exemplary equipment rental tracking process, consistent with the present invention.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

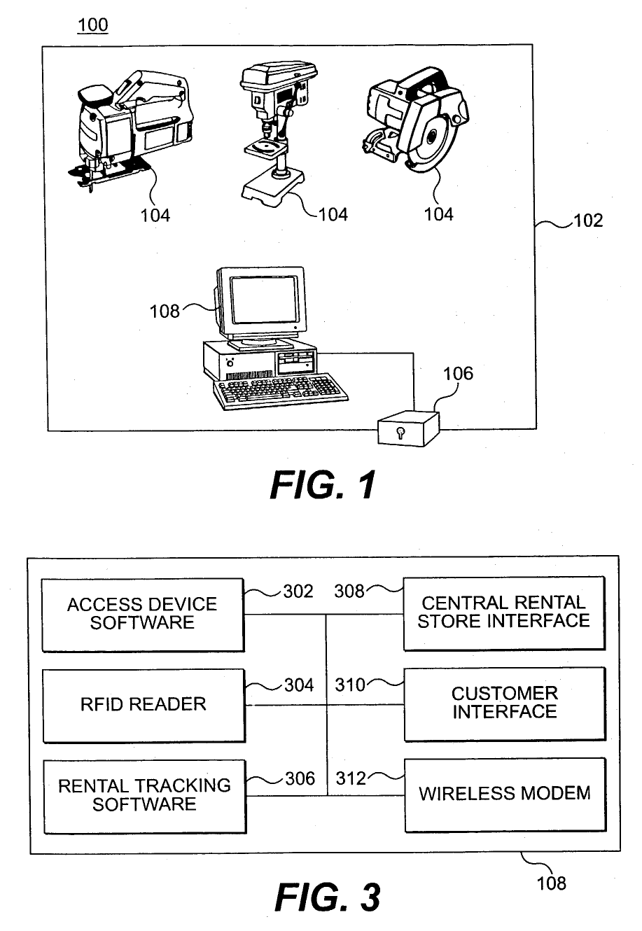

FIG. 1 illustrates a rental equipment business system 100, consistent with an exemplary embodiment of the present invention. Rental equipment business system 100 may be, for example, a portable autonomous rental store. Rental equipment business system 100 may include a portable rental container 102 that may contain rental equipment 104, an access device 106, and a computer 108. Portable rental container 102 may be, for example, a shipping container or trailer. In one embodiment, portable rental container 102 may be located at a customer site, such as a construction site. One skilled in the art will appreciate that rental equipment business system may be implemented using a portable building or containment area that may be assembled at a location specified by a customer.

Rental equipment 104 may include, for example, large equipment, such as bulldozers, automobiles, or other machinery, small equipment, such as jackhammers, air compressors, or tools, and accessories such as hoses or tools. Rental equipment 104 may also include goods such as fuel, oil, feed, fluids, gloves, saw blades, drill bits, etc. As used herein, the term “equipment” encompasses a broad array of tangible equipment and/or goods to be rented or purchased. Portable rental container 102 may include, for example, a general inventory of equipment that is typically needed by customers. The container may also include equipment specifically requested by a customer. Although three items are depicted in FIG. 1, one of skill in the art will appreciate that any number of pieces of equipment may be provided in portable rental container 102.

In one embodiment the container may contain general inventory received by customers. In another embodiment, the container may contain inventory associated with the type of work being performed by the customer. In another embodiment, the portable container may include inventory based upon a specific customer's prior uses and/or type of business. The configuration of portable rental container 102 may be determined using computer 108.

In some embodiments, the portable rental container may contain separate sections that can be accessed with different access codes. For example, more expensive or sensitive equipment may be available only to certain people at the customer site and may be separately secured within the portable rental container. Different access codes or access devices may be used for a first secured area and a second secured area. It is contemplated that different areas may be used for equipment pick-up and for equipment return.

Access device 106 may control access to portable rental container 102 and may include, for example, a magnetic card reader, an electronic lock, a combination lock, etc. Alternatively, access device 106 may be any other locking mechanisms with electronic activation to control access to rental equipment 104 such as, for example, a wheel lock, a chain and padlock, or an electrically activated pin through a vehicle's hitch. Access device 106 may include an input mechanism, for example, a card reader, keypad, or transponder, that enables a user to input identification information.

One or more people associated with a customer may be given means to use access device 106 to enter portable rental container 102 and/or access rental equipment 104. For example, the access means may be a magnetic swipe card, a code for an electronic lock, a lock combination, a key, etc. In one embodiment, access device 106 may be released automatically or in an automated manner. For example, the access device may automatically disarm at 8:00 a.m. and re-arm at 4:00 p.m. In one embodiment, an access controller may re-lock after a predetermined amount of time or in response to movements inside the portable rental container.

In one embodiment, a customer may access portable rental container 102 each time a piece of equipment is rented or returned. Alternatively, a customer may access portable container 102 and leave it open for anyone needing equipment. Equipment may be sensed as it is removed or returned and/or each user may provide identification in order to remove and/or return equipment.

In one embodiment, access device 106 may receive input from a customer and communicate the input (or a portion thereof) to a computer such as computer 108 or a remote computer system. The computer may determine and/or verify that the customer should have access to portable rental container 102 and communicate the approval/rejection back to access device 106. In an alternative embodiment, access device 106 may include enough information locally to verify authorized access without communication with a remote system or computer 108.

Computer 108 may include software and hardware to support rental equipment business system 100. For example, computer 108 may note the identity of a person accessing portable rental container 102 and track when rental equipment 104 is removed from and/or returned to portable rental container 102. Computer 108 may communicate with access device 106 using a wireless local area network, a wide area network, the Internet, or any other communications network using wireless or hardwired connections. Computer 108 may maintain a record of those who enter portable rental container 102. Computer 108 may include a printer to provide, for example, a printed receipt to a customer. The printed receipt may include, for example, customer identity, time, date, a list of equipment returned or removed, and a list of equipment usage and/or rental or purchase charges.

Rental equipment business system 100 may track equipment using, for example, RFID tags, bar codes, or other information tags. For example, a piece of rental equipment 104 may include an RFID tag that, when scanned by a sensor, provides information relating to the identification of the equipment and/or information relating to the status of equipment. Information relating to the identification of the equipment may include, for example, the type of equipment, a serial number associated with the equipment, and/or information about the configuration of the equipment. Information relating to the status of the equipment may include the number of miles or hours that the equipment has been in operation and/or the equipment's maintenance/health information, such as fault codes, diagnostic data, maintenance needs, etc.

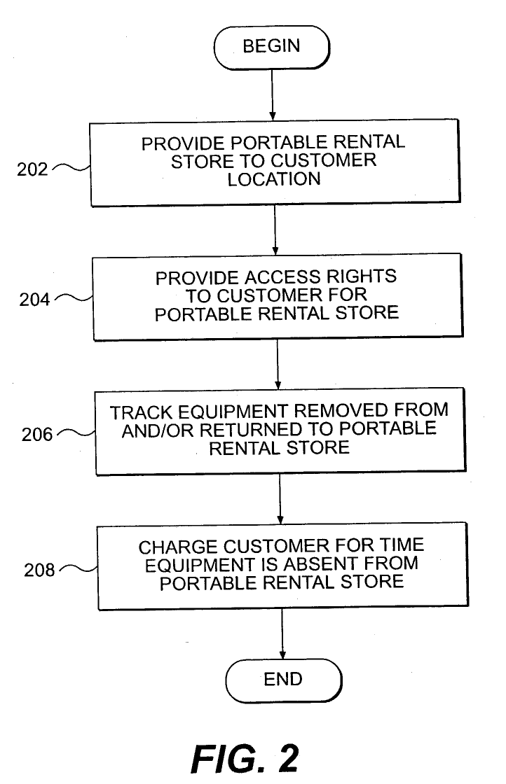

FIG. 2 is a flowchart of an exemplary equipment rental process using rental equipment business system 100. A rental business may provide a portable rental store to a desired site, such as a customer location (step 202). For example, an existing rental customer may request that a portable rental store be established for the customer's construction site to facilitate equipment rental at that site. The portable rental store may include a general inventory of equipment for rent and/or specific equipment based on a customer's needs and/or requests. The rental business may also provide access rights to the customer for accessing the portable rental store (step 204). For example, the customer may be given a magnetic card or access code to be used in an access device on the portable rental store. The rental system tracks equipment as it is removed from and/or returned to the portable rental store (step 206), and the customer may be charged for the time the equipment is absent from the portable rental store (step 208).

FIG. 3 illustrates components of an exemplary embodiment of rental equipment business system 100. In one embodiment, these components may be included in computer 108 and may comprise access device software 302, radio frequency identification (RFID) reader 304, rental tracking software 306, central rental store interface 308, customer interface 310, and a wireless modem 312. One skilled in the art will recognize that these components may be separated and that rental equipment business system 100 may not include all of these components.

Access device software 302 may control access device 106 using any electronic access method. Access device software 302 may also identify a person using access device 106 and/or accessing portable rental container 102. For example, each person associated with a customer may receive a unique code for use with access device 106, for example, an electronic lock securing portable rental container 102. When a code is entered into access device 106, the identity of the specific person accessing portable rental container 102 may be detected by access device software 302. Alternatively, other identification methods may be used, such as fingerprint or other biometric technology or a swiped identification card. Although FIG. 3 depicts access device software 302 as part of computer 108, one of ordinary skill in the art will appreciate that these functions may be performed by access device 106 or by an access device controller separate from computer 108.

RFID reader 304 may employ radio frequency identification (RFID) technology to track what rental equipment 104 is removed from and/or returned to portable rental container 102. For example, each piece of rental equipment 104 may be marked with an RFID tag that is read when the piece of equipment passes RFID reader 304. RFID reader 304 may be part of computer 108 (as shown) or it may be separate from computer 108. For example, RFID reader 304 may be mounted on or near the door to portable rental container 102 to ensure that each piece of equipment removed or returned passes RFID reader 304. Alternatively, RFID reader 304 may conduct periodic polling of the RFID tags of all equipment located in portable rental container 102, enabling the detection of the return and/or removal of a piece of equipment. Although this description discusses RFID technology, one of ordinary skill in the art will appreciate that any other methods for gathering information, such as magnetic technology bar-code readers, or manual inspections, may be used to track the removal and/or return of rental equipment consistent with the present invention.

In an embodiment, one or more pieces of rental equipment may include a global positioning satellite (GPS) receiver that reports location information to the portable rental container or a central rental store. In this way, the location of the equipment may be monitored to determine when utilization has begun. For example, in one embodiment, the location of the equipment may be tracked. When the location information from the equipment indicates it has moved from the portable container 102, the equipment may be construed to be checked out. For example, if one or more pieces of location information (e.g. coordinates) are associated with the portable container, then the location (e.g. coordinates) of the equipment may be compared with the location of the portable container. If the equipment coordinates exceed a specified radius of the portable container, the equipment may be construed to be checked out. Similarly, if a piece of equipment moves within a specified radius of the portable container, the equipment may be construed to be checked in. In addition, machine usage may be tracked through the wireless communication. In one embodiment, the wireless communication may be used to relay usage information, thereby enabling tracking of machine utilization.

Rental tracking software 306 may be used to track the identity of a person accessing portable rental container 102 together with what rental equipment 104 is removed from and/or returned to portable rental container 102. For example, access device 106 may determine a customer's identity and provide that information to rental tracking software 306. RFID reader 304 may track equipment that is removed and/or returned and provide that information to rental tracking software 306. In this way, tracking software 306 may store the customer's identity with the equipment rental data. Rental tracking software 306 may determine how long the pieces of equipment were absent, making it possible to bill a customer for the actual time a piece of rental equipment was rented. In one embodiment, the data read from a piece of equipment may include a measurement of actual usage, such as machine hours or miles traveled. Rental tracking software 306 may use this data to bill a customer for specific usage. In one embodiment, rental tracking software 306 may use collected data to generate a rental/purchase agreement and/or an invoice. The rental tracking software may also generate a message to be delivered to a central data facility based on equipment usage.

In one embodiment, computer 108 may generate an invoice or rental/purchase agreement for the equipment taken from the portable rental container based on identification information entered by the customer on entry. An invoice may be provided, for example, every time a customer accesses the portable rental container and/or specifically requests an invoice. Alternatively, an invoice may not be provided to the customer and the customer may be billed at the end of the month. For example, computer 108 may run a monthly report to bill a customer for all rental/purchase activity over the month. As an example, a customer may have removed a machine for six hours on June 5th and removed another machine on June 14th and returned it on July 20th. Computer 108 may produce an invoice for the month of June containing charges for both rentals, or the June invoice may contain the first rental (i.e., the machine used on June 5th) and a July invoice may contain the second rental (i.e., the machine returned on July 20th). An invoice may include, for example, a monthly fee, a charge for any equipment and/or goods purchased, an estimated charge for rental of equipment, and/or a charge based on actual usage of equipment (e.g., from information received from the equipment). It is contemplated that some or all billing functions may be performed at a central rental store in a location remote from the portable rental store.

Central rental store interface 308 may provide communication between portable rental container 102 and a central rental store (not shown). In this manner, the central rental store may maintain customer accounts, ordering information, billing information, etc. By communicating with portable rental container 102, the central rental store may receive periodic updates of what equipment has been rented by a customer and for how long. In this way, the central rental store may be constantly up-to-date on the activities within portable rental container 102. The central rental store may then create updated bills for a customer based on the customer's rentals as tracked by rental tracking software 306 at the portable rental store.

Further, the central rental store may monitor what rental equipment a customer is renting from portable rental container 102 and remove any equipment that is not being used, making the equipment available to other customers. This may occur as a “snap shot” in time decision, or after tracking/analyzing usage over a period of time to determine that a customer does not have a need for a particular price of equipment. In addition, based on tracked usage, it may be decided to provide a customer with access to additional pieces of equipment. For example, a customer may be given access to multiple pieces of the same equipment or additional pieces of application-related equipment. In one embodiment, the central rental store may monitor status information about the equipment, such as repair needed or low fuel, and provide service to keep the rental equipment available and functional at the customer site. In one embodiment, workers at the central rental store may use interface 308 to reconfigure computer 108. For example, the central rental store may receive information over a wireless connection from the computer 108 or the equipment itself. Further, to save money, data may be stored locally at the portable rental container and transmitted to the central rental store via satellite communication at off-peak times, such as the middle of the night, when rates are lower. Alternatively, data may be transferred manually by a rental clerk.

Customer interface 310 may be used by a customer to communicate with computer 108, for example to obtain records of recent rentals or to order additional rental equipment to be placed in portable rental container 102. Customer interface 310 may enable a customer to access a wide area network, such as the Internet, and customer interface 310 may track and/or bill for the customer's network usage. In this way, a customer may rent an Internet portal for use on the customer site. Customer interface 310 may enable a customer to communicate with a central rental store via central rental store interface 308.

Wireless modem 312 may provide communication between computer 108 and a local area network, a wide area network, such as the Internet, or another portable rental container located on the customer site or elsewhere. In one embodiment, wireless modem 312 enables communication between portable rental container 102 and a central rental store. In addition, the wireless modem may be used to connect one or more of multiple pieces of equipment, portable rental containers, central rental store, and/or customer site or field management software. Wireless modem 312 may use 802.11 technology, satellite technology, cellular technology, etc. Power for rental system 100 may be provided by the customer site, for example, or may be provided, for example, by a solar array located on the top of portable container 102, or a portable power generator.

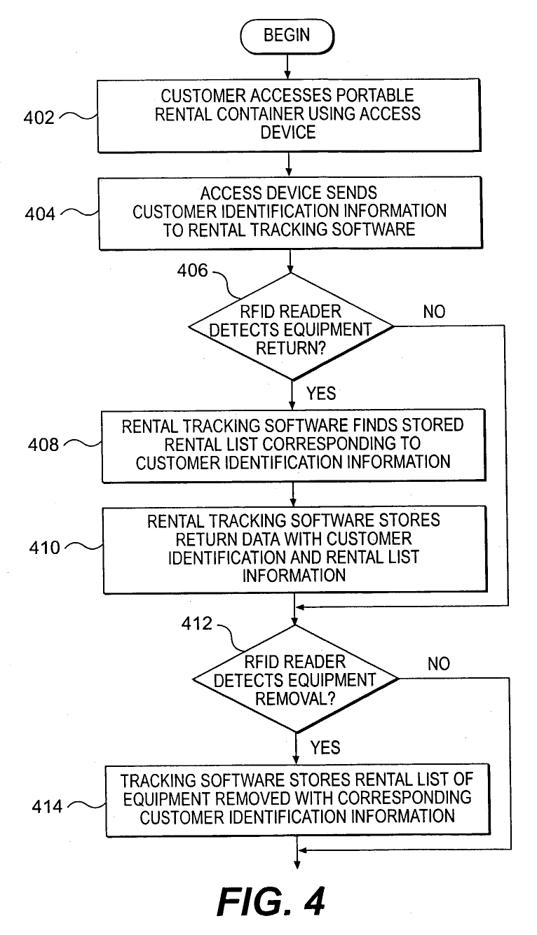

FIG. 4 is a flowchart of an exemplary equipment rental tracking process using rental equipment business system 100. When a customer accesses portable rental container 102 using access device 106 (step 402), access device 106 may send customer identification information to rental tracking software 306 (step 404). As described above, in selected embodiments, access device software 302 may receive customer identification information as part of an access code or magnetic swipe card. If RFID reader 304 detects equipment returned to portable rental container 102 (step 406), then rental tracking software 306 finds a stored rental list corresponding to the customer identification information (step 408). A rental list may have been stored, for example, when the customer removed the equipment. If equipment return is detected but no stored rental list is found, then an alert may be set. In this case, rental store personnel may be prompted to determine the status of such equipment. Rental tracking software 306 may store return data (e.g., time and date of return, equipment identification, equipment utilization, equipment status, etc.) with the rental list and customer identification information (step 410). If RFID reader 304 detects equipment removed from portable rental container 102 (step 412), then rental tracking software 306 may store rental data (e.g., time and date of rental, equipment identification, equipment status, etc.) in a rental list with the corresponding customer identification information (step 414).

In some embodiments, rental equipment business system 100 may include one or more cameras to record activity in and/or around portable rental container 102. The cameras may automatically begin recording when customer input is received at access device 106 and record activity for a predetermined amount of time. Alternatively, cameras may record constantly and when the customer accesses portable rental container 102, the time/date or a tape locator may be stored to create a video history of the customer's access. The recording could be used, for example, for security purposes or to note the condition of equipment picked up and returned, or to track utilization.

In some embodiments, rental equipment business system 100 may include a web site or catalog listing pieces of equipment available for rent or purchase. A customer may access the web site or catalog to determine if the needed equipment is available and, if so, the customer may request that the equipment be added to portable rental container 102. This may be performed, for example, by a customer using customer interface 310 to communicate with a central rental store via central rental store interface 308.

In one embodiment, the user may enter an application being performed on the work site. Computer 108 and/or a central rental store may then automatically determine what equipment will be needed to perform the application (e.g., using look-up tables, etc.), check the inventory of the portable container, and stock the portable container accordingly. In one embodiment, the computer 108 or central rental store may track the utilization of equipment and automatically determine what other equipment will be needed later (e.g., for a particular application), check the inventory of the portable container, and stock the portable container accordingly, in advance of when the customer actually needs the equipment.

In one embodiment, portable rental container may include hardware and/or software to provide a wireless local area network (LAN). For example, a customer could rent personal digital assistants, modems, and/or other wireless communication devices that communicate via computer 108. For example, workers on a construction site may rent personal digital assistants that communicate with one another and/or the equipment across the construction site using a modem on computer 108. In this way, a customer may rent a wireless LAN at the customer's site.

### INDUSTRIAL APPLICABILITY

Systems and methods are thus provided for improving the availability of equipment in a rental business. Specifically, systems consistent with the present invention may give a customer access to rental equipment twenty four hours per day, seven days per week at a customer site. Renting equipment in such a system does not require picking up and/or dropping off equipment at a rental store. Instead, the equipment is securely available at a customer site. As discussed above, equipment includes both conventional rental machinery/accessories and/or goods.

Furthermore, the disclosed system may enable a customer quickly to obtain rental equipment that had not been anticipated. Because rental equipment is securely available at a customer site, a customer does not need to pre-arrange to have equipment available.

In addition to improving rental equipment availability, the disclosed systems and methods may provide for billing for the actual usage of rental equipment, saving customers money and time. Because rental equipment is securely available at a customer site and can be checked in and out essentially at any time, a customer does not have to pay for extra time for equipment pick-up and return.

The described systems and methods may be applied to any rental business, including, for example, furniture rental, office machinery rental, and household appliance and tool rental. Large equipment rental, such as machine equipment rental (e.g., construction, paving, farm, forestry, loading, etc.) and car rental is also provided for.

It will be readily apparent to those skilled in this art that various changes and modifications of an obvious nature may be made, and all such changes and modifications are considered to fall within the scope of the appended claims. For example, the disclosed systems and methods may be applied to fenced yard on a customer's site suitable for storing large equipment, such as trucks or construction machinery, that is available for rent. Access to the fenced yard may be controlled, for example, by an automatic gate. In another example, portable rental container 102 may be used for secure parts or supplies deliveries by suppliers at any time of the day or night.

Other embodiments of the invention will be apparent to those skilled in the art from consideration of the specification and practice of the invention disclosed herein. It is intended that the specification and examples be considered as exemplary only, with a true scope of the invention being indicated by the following claims and their equivalents.

What is claimed is:

1. A method of managing rental equipment, comprising:
sensing an identity of a customer accessing a portable container;
detecting removal of a piece of equipment from the portable container; and
tracking usage of the piece of equipment based on the identity and the removal detection.

2. The method of claim 1, further including:
detecting return of the piece of equipment to the portable container.

3. The method of claim 2, further including:
charging the customer for usage of the piece of equipment based on the detected removal and the detected return.

4. The method of claim 1, wherein the portable container is located on a site chosen by the customer.

5. The method of claim 1, further including:
automatically recording what equipment the customer removes from the portable container.

6. The method of claim 5, further including:
starting a recording device when the identity of the customer is sensed; and
stopping the recording device after a predetermined amount of time has passed.

7. The method of claim 6, wherein the recording device includes one or more security cameras.

8. The method of claim 1, wherein the portable container includes a general inventory of rental equipment.

9. The method of claim 1, wherein the removal detection includes at least one of: an identification of the piece of equipment, a removal date, and a removal time.

10. The method of claim 9, wherein the removal detection further includes a status of the piece of equipment.

11. The method of claim 2, wherein the return detection includes at least one of: an identification of the piece of equipment, a return date, and a return time.

12. The method of claim 11, wherein the return detection further includes a status of the piece of equipment.

13. The method of claim 1, further including:
authorizing access to the portable container, and
sensing the identity of the customer based on the authorization.

14. The method of claim 1, further including:
authorizing access to the portable container based on the sensed identity.

15. A method of managing rental equipment, comprising:
sensing an identity of a customer accessing a portable container;
detecting replacement of a piece of equipment to the portable container; and
tracking usage of the piece of equipment based on the identity and the replacement detection.

16. The method of claim 15, further including:
matching the replacement detection to data stored when removal of the piece of equipment was detected.

17. The method of claim 16, further including:
charging the customer for usage of the piece of equipment based on the replacement detection and the stored data.

18. The method of claim 15, wherein the portable container is located on a site chosen by the customer.

19. The method of claim 15, wherein the replacement detection includes at least one of: an identification of the piece of equipment, a replacement date, and a replacement time.

20. The method of claim 19, wherein the replacement detection further includes a status of the piece of equipment.

21. The method of claim 15, wherein the portable container includes equipment associated with the type of work performed by the customer.

22. The method of claim 15, wherein the portable container includes equipment based upon the customer's prior equipment usage.

23. The method of claim 15, wherein the portable container includes equipment requested by the customer.

24. A method of providing rental equipment to a customer, comprising:
providing a customer-specific rental facility containing a piece of equipment at a location chosen by the customer;
authorizing the customer to access the customer-specific rental facility;
detecting removal of the piece of equipment from the customer-specific rental facility;
detecting return of the piece of equipment to the customer-specific rental facility; and
tracking usage of the piece of equipment.

25. The method of claim 24, wherein the usage is tracked based on at least one of: the detected removal and the detected return.

26. The method of claim 24, further including:
sensing an identity of a person accessing the customer-specific rental facility.

27. The method of claim 24, further including:
charging the customer for renting the piece of equipment based on the tracked usage.

28. The method of claim 24, wherein the customer-specific rental facility is used by more than one customer at a single location.

29. A system for managing rental equipment comprising:
a portable container containing a piece of equipment for rent;
an access controller that selectively allows a customer to access the portable container; and
a sensor that detects removal of the piece of equipment from the portable container.

30. The system of claim 29, wherein the sensor detects return of the piece of equipment to the portable container.

31. The system of claim 29, wherein the sensor includes at least one of: a radio frequency identification tag reader, a bar code reader, magnetic detection technology, and a GPS-based sensor.

32. The system of claim 29, further including:
a rental tracking system that notes an identity of a person accessing the portable container and tracks usage of the piece of equipment.

33. The system of claim 29, further including:
a communication device for sending data about the piece of equipment to a location remote from the portable container

34. The system of claim 33, wherein the communication device includes at least one of: a wireless modem, a satellite transmitter, and an Internet connection.

35. The system of claim 29, further including:
a purchase tracking system that detects that the piece of equipment is a non-reusable product and charges the customer for purchase of the non-reusable product.

36. A system for providing a portable wireless communications infrastructure to a customer, comprising:
a local communication interface provided at a customer site;
a remote computer connected to the local communication interface via a wide area network; and
a wireless device at the customer site that communicates data about the equipment to the remote computer via the local communication interface.

37. The system of claim 36, wherein the wireless device receives data about equipment rental from the remote computer via the local communication interface.

38. The system of claim 36, wherein the local communication interface includes at least one of: a wireless modem, an Internet connection, and a satellite transmitter.

39. The system of claim 36, wherein the wireless device is provided to the customer.

40. The system of claim 36, wherein the wireless device is located on the equipment.

41. The system of claim 36, wherein the data about the equipment includes at least one of:
equipment rental information and equipment status information.

42. A system for managing rental equipment comprising:
a portable container containing a piece of equipment for rent and a local communication interface;
an access controller that selectively allows a customer to access the portable container; and
a remote computer that receives data about the piece of equipment from the local communication interface via a wide area network.

43. The system of claim 42, further including:
a sensor that detects removal of the piece of equipment from the portable container.

44. The system of claim 42, further including:
a wireless device that communicates data about the equipment to the remote computer via the local communication interface.
